(19) United States
(12) Patent Application Publication
(10) Pub. No.: US 2008/0093785 A1
(43) Pub. Date: Apr. 24, 2008

(54) FLUID-FILLED TYPE VIBRATION DAMPING DEVICE

(75) Inventor: Atsushi MURAMATSU, Komaki-shi (JP)

Correspondence Address: ROSSI, KIMMS & McDOWELL LLP., P.O. BOX 826, ASHBURN, VA, 20146-0826, US

(73) Assignee: TOKAI RUBBER INDUSTRIES, LTD., Komaki-shi (JP)

(21) Appl. No.: 11/874,864

(22) Filed: Oct. 18, 2007

(30) Foreign Application Priority Data
Oct. 20, 2006 (JP) 2006-285600

(51) Int. Cl. F16F 13/00

(52) U.S. Cl. 267/140.13

(57) ABSTRACT

A fluid-filled type vibration-damping device wherein first and second mounting members are connected by a main rubber elastic body defining a pressure receiving chamber connected via an orifice passage to an equilibrium chamber defined by a flexible diaphragm. A partition member dividing both chambers is elastically supported by the second mounting member such that an outer rim of the partition member is pinched between a first support rubber elastic body and a second support rubber elastic body, while being spaced away radially inwardly from the second mounting member, whereby the partition member is displaceable relative to the second mounting member due to elastic deformation of the first and second elastic support bodies to provide a fluid pressure absorbing mechanism to check pressure fluctuation in the pressure receiving chamber to the equilibrium chamber.

### INCORPORATED BY REFERENCE

The disclosure of Japanese Patent Application No. 2006-285600 filed on Oct. 20, 2006 including the specification, drawings and abstract is incorporated herein by reference in its entirety.

### BACKGROUND OF THE INVENTION

1. Field of the Invention

The present invention relates in general to vibration damping devices for use as automotive engine mounts or the like, and more particularly to a fluid-filled type vibration damping device capable of exhibiting vibration damping effect by utilizing fluid flow action of non-compressible fluid sealed therein.

2. Description of the Related Art

There has been proposed in vibration damping devices interposed between components making up a vibration transmitting system to utilize vibration damping effect based on flow action like resonance of non-compressible fluid sealed therein. One example of a fluid-filled type vibration-damping device comprises: a first mounting member fixable to one of components linked together in vibration damping fashion; a second mounting member fixable to the other of components linked together in vibration damping fashion; a main rubber elastic body elastically connecting the first and second mounting members disposed in a spaced away fashion; a pressure receiving chamber partially defined by the main rubber elastic body and induce pressure fluctuation upon input of vibration; an equilibrium chamber partially defined by a flexible film and is readily changeable in volume; a partition member separating from each other the pressure receiving chamber and the equilibrium chamber that are disposed on opposite sides thereof; and an orifice passage for permitting a fluid communication between the pressure receiving chamber and the equilibrium chamber. Such a fluid-filled type vibration damping device is able to be utilized as the automotive engine mount advantageously.

Another type of fluid filled vibration damping device includes a fluid pressure absorbing mechanism, e.g., a rubber film or a movable plate disposed in the partition member. In the fluid-filled type vibration damping device having the fluid pressure absorbing mechanism, upon input of high frequency and small amplitude vibration, pressure fluctuation in the pressure receiving chamber is able to be transmitted or checked to the equilibrium chamber by means of slight deformation of the rubber film or slight displacement of the movable member, making it possible to exhibit vibration damping capability with respect to the high frequency and small amplitude vibration.

However, such a fluid-filled type vibration damping device equipped with the fluid pressure absorbing mechanism is likely to cause the problem of increased number of components and the resultant complication of structure. As a result, efficiency in manufacturing such a device would be deteriorated.

US 2001/0004141 A1 discloses a fluid-filled type vibration damping device wherein a fluid pressure absorbing mechanism is formed of a rubber elastic body and integrally with the partition member. However, if the fluid pressure absorbing mechanism (i.e. a central flexible portion) of the rubber elastic body is integrally formed with the partition member, it become difficult to coincidentally establish with efficiency: the first vibration damping effect with respect to low frequency and large amplitude vibration on the basis of flow action of the fluid flowing through the orifice passage; and the second vibration damping effect with respect to high frequency and small amplitude vibration on the basis of pressure absorbing effect by means of slight deformation of the central flexible portion. Furthermore, due to increase in the number of components formed of rubber elastic body, efficiency in manufacturing the vibration damping device would be deteriorated.

### SUMMARY OF THE INVENTION

It is therefore one object of this invention to provide a fluid-filled type vibration damping device of novel construction thereby providing a fluid pressure absorbing mechanism with the reduced number of components and with simple structure, and making it possible to concurrently exhibit the first vibration damping effect on the basis of flow action of fluid flowing through the orifice passage, and the second vibration damping effect owing to fluid pressure absorbing effect by means of the fluid pressure absorbing mechanism.

The above and/or optional objects of this invention may be attained according to at least one of the following modes of the invention. The following modes and/or elements employed in each mode of the invention may be adopted at any possible optional combinations. It is to be understood that the principle of the invention is not limited to these modes of the invention and combinations of the technical features, but may otherwise be recognized based on the teachings of the present invention disclosed in the entire specification and drawings or that may be recognized by those skilled in the art in the light of the present disclosure in its entirety.

According to a principle of the present invention, there is provided a fluid-filled vibration damping device comprising: a first mounting member; a second mounting member of tubular shape, the first mounting member disposed on a first axial open-end side of the second mounting member with a space therebetween; a main rubber elastic body elastically connecting the first mounting member and the second mounting member with a central portion thereof being bonded by vulcanization to the first mounting member and with an outer circumferential portion thereof being bonded by vulcanization to the second mounting member; a partition member supported by the second mounting member such that the partition member spreads in an axis perpendicular direction to form on one side thereof a pressure receiving chamber partially defined by the main rubber elastic body and on an other side thereof an equilibrium chamber partially defined by a flexible film, the pressure receiving chamber and the equilibrium chamber being filled with non-compressible fluid sealed therein; and an orifice passage for connecting the pressure receiving chamber and the equilibrium chamber to each other. The outer circumferential portion of the main rubber elastic body extend axially inwardly on an inner circumferential surface of the second mounting member to form a first support rubber elastic body, an outer peripheral portion of the partition member is superposed onto an axial end face of the first support rubber elastic body while being spaced away radially inwardly from the second mounting member, an annular second support rubber elastic body is assembled into the second mounting member from a second axial open end side of the second mounting member such that the second support rubber elastic body is superposed in an axial direction onto the outer peripheral portion of the partition member on a side opposite from the first support rubber elastic body so that the partition member is pinched between the first support rubber elastic body and the second support rubber elastic body, the partition member thereby being supported with respect to the second mounting member in a displaceable fashion owing to elastic deformation of the first and second elastic support bodies so as to provide a fluid pressure absorbing mechanism capable of transmitting fluid pressure fluctuation of the pressure receiving chamber to the equilibrium chamber to absorb the fluid pressure fluctuation.

In the fluid filled type vibration damping device of construction according to the present invention, the partition member is elastically pinched by the first support rubber elastic body and the second support rubber elastic body, whereby the partition member is supported by the second mounting member while being slightly movable relative to the second mounting member. With this arrangement, the fluid pressure absorbing mechanism in order to cheke fluid pressure fluctuation in the pressure-receiving chamber to the equilibrium chamber is produced by means of the partition member. Thus, the fluid pressure absorbing mechanism can be realized with simple construction by utilizing the partition member dividing the pressure receiving chamber and the equilibrium chamber from each other.

Preferably, the second support rubber elastic body and the flexible film are formed integrally. This arrangement makes it possible to reduce the number of components formed of rubber elastic body, leading to enhanced efficiency in manufacturing the fluid-filled type vibration damping device.

In another preferred form of the fluid filled type vibration damping device of the present invention, a fixing member is fixed to the second axial open end side of the second mounting member, and the second support rubber elastic body is assembled to the second mounting member by means of the fixing member. With this arrangement, the second support rubber elastic body can be fixed stably to the second mounting member.

In yet another preferred form of the fluid filled type vibration damping device of the present invention, a sealing rubber is formed integrally with the second support rubber elastic body so as to extend over an entire circumference of an outer circumferential portion of the second support rubber elastic body, and is pinched in the axial direction between the second mounting member and the fixing member. With this arrangement, a desired sealing can be readily realized at a connecting portion between the second mounting member and the fixing member. Furthermore, since the sealing rubber is formed integrally with the second support rubber elastic body, it is possible to reduce the number of components.

In yet another preferred form of the fluid filled type vibration damping device of the present invention, the sealing rubber has an axial length smaller than that of the second support rubber elastic body. With this arrangement, the compression ratio of the sealing rubber in the axial direction (i.e. the ratio of the amount of compression of rubber to the initial size of rubber) can be made larger than the compression ratio of the second support rubber elastic body in the axial direction. Thus, the second support rubber elastic body and the sealing rubber, which are formed integrally, are able to effectively realize concurrently floating support of the partition member by means of the second support rubber elastic body, and a desired sealing by means of the sealing rubber.

In still another preferred form of the fluid filled type vibration damping device of the present invention, an outer rim of the fixing member is fixed by caulking against the second mounting member so that by means of the fixing member the second support rubber elastic body is superposed against onto the partition member to pinch the partition member between the first and second support rubber elastic bodies in the axial direction, while the sealing rubber is pinched between the fixing member and the second mounting member in the axial direction. With this arrangement, by firmly fixing the fixing member against the second mounting member, the second support rubber elastic body is hermetically held in contact with the partition member, and fluid-tight sealing between the second mounting member and the fixing member can be realized readily by means of the sealing rubber.

In still further preferred form of the fluid filled type vibration damping device of the present invention, the partition member is of thin circular disk shape, and the second support rubber elastic body is of annular block shape, while the orifice passage is formed by closing an opening of a groove formed onto the second support rubber elastic body by means of the partition member. With this arrangement, by providing the partition member in thin circular disk shape, the partition member will readily undergo slight displacement effectively upon input of slight vibration, making it possible to exhibit high precise vibration damping effect by means of the fluid pressure absorption effect.

### BRIEF DESCRIPTION OF THE DRAWINGS

The foregoing and/or optional objects, features and advantages of the invention will become more apparent from the following description of a preferred embodiment with reference to the accompanying drawings in which like reference numerals designate like elements and wherein:

FIG. 1. is an elevational view in vertical cross section of a fluid-filled type vibration damping device in the form of an automotive engine mount according to a first embodiment of the present invention;

FIG. 2 is an elevational view in vertical cross section of a fluid-filled type vibration damping device in the form of an automotive engine mount according to a second embodiment of the present invention; and

FIG. 3 is an elevational view in vertical cross section of a fluid-filled type vibration damping device in the form of an automotive engine mount according to a third embodiment of the present invention.

### DETAILED DESCRIPTION OF PREFERRED EMBODIMENTS

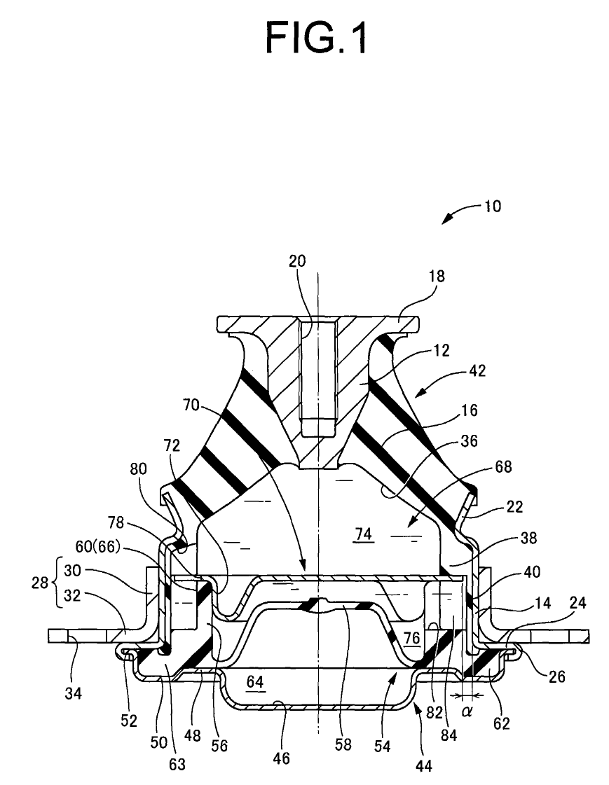

Referring first to FIG. 1, shown is a fluid-filled type vibration damping in the form of an automotive engine mount 10 of construction according to a first embodiment of the present invention. The engine mount 10 includes a first mounting member 12 of metal and a second mounting member 14 of metal, which are elastically connected together by means of a main rubber elastic body 16. The first mounting member 12 is attached to the power unit of the automotive vehicle, while the second mounting member 14 is attached to the body of the vehicle, so that the power unit is supported with respect to the body of the vehicle in a vibration damping fashion. In the description hereinbelow, unless indicated otherwise, vertical direction refers to the vertical direction in FIG. 1.

More specifically described, the first mounting member 12 is a generally round cylindrical metal member extending in the axial direction of the engine mount 10. At the axially upper end portion of the first mounting member 12, a flange portion 18 is formed integrally so as to spread outwardly in the axis-perpendicular direction. In the present embodiment, the first mounting member 12 has a tapered shape with an outer diameter gradually decreases as it goes from its intermediate portion to the lower end portion. Furthermore, the first mounting member 12 has a tapped hole 20 extending straightly on its center axis. By screwing a mounting bolt into the tapped hole 20, the first mounting member 12 is fixed to the power unit of the automotive vehicle (not shown).

The second mounting member 14 has a generally round tube shape with a thin wall-thickness and a large diameter. The second mounting member 14 has an annular throttle portion at its axially intermediate position, so that on the axially upper side of the annular throttle portion is formed integrally a tapering portion 22 of tapered tube shape with a diameter gradually increases as its goes to axially upwardly, and on the axially lower side of the annular throttle portion is formed integrally an abutting flange 24 of flange shape spreading outwardly in the axis-perpendicular direction. Furthermore, a caulking portion 26 is formed integrally at an outer rim of the abutting flange 24, so as to extend axially downwardly.

Moreover, a bracket 28 is assembled with the second mounting member 14. This bracket 28 includes a fitting portion 30 of generally round tubular shape, and a fixing portion 32 spread radially outwardly from the axially lower end portion of the fitting portion 30. The fixing portion 32 has a plurality of bolt holes 34 each axially perforating therethrough at respective circumferential positions. The bracket 28 is press fitted onto the second mounting member 14 such that the fitting portion 30 is disposed radially outwardly on the second mounting member 14, while the inner circumferential portion of the fixing portion 32 is superposed on the abutting flange 24 from the axially upper position. With the second mounting member 14 assembled with the bracket 28, by means of mounting bolts (not shown) extending through the bolt hole 34, the fixing portion 32 is fixedly attached to the body of the vehicle (not shown).

The first and second mounting members 12, 14 are concentrically disposed while being spaced away from each other, and elastically connected together by means of the main rubber elastic body 16. The main rubber elastic body 16 is formed of a rubber elastic body having a generally frustoconical shape, and has a circular recess 36 open in its large-diameter side end face, while opening axially downwardly. On the radially outer side of the circular recess 36, there is formed an elastic support rubber 38 serving as a first support rubber elastic body so as to surround the circular recess 36. The elastic support rubber 38 has a thick walled generally round tubular shape overall, and is integrally formed at an outer circumferential portion of the large-diameter side end face of the main rubber elastic body 16 so as to extend axially downwardly. At the outer peripheral edge of the elastic support rubber 38, a sealing rubber layer 40 is integrally formed. The sealing rubber layer 40 has a round tubular shape with a wall thickness smaller than that of the elastic support rubber 38, and extend axially downwardly from an outer peripheral edge of the axially lower end of the elastic support rubber 38.

The small diameter end side of the main rubber elastic body 16 is bonded by vulcanization to the first mounting member 12 axially embedded therein, while the outer circumferential surface of the large-diameter end portion of the main rubber elastic body 16 including the elastic support rubber 38 is bonded by vulcanization to the second mounting member 14. As will be understood from the aforementioned description, in the present embodiment, the main rubber elastic body 16 is used to provide an integrally vulcanization molded product 42 equipped with the first mounting member 12 and the second mounting member 14. In the present embodiment, the main rubber elastic body 16, the elastic support rubber 38 and the sealing rubber layer 40 are all bonded by vulcanization to the inner circumferential surface of the second mounting member 14, so that the inner circumferential surface of the second mounting member 14 is substantially entirely coated by the rubber elastic body. In this embodiment, the lower end portion of the sealing rubber layer 40 extends axially downwardly beyond the abutting flange 24 of the second mounting member 14.

A bottom member 44 of metal serving as a fixing member is also assembled to the second mounting member 14. The bottom member 44 is a metal member of shallow dish shape overall, and includes a bottom wall portion that has a stepped circular disk shape extending in the axis perpendicular direction. That is, a circular cavity 46 is formed at a diametrically central portion of the bottom member 44, and is disposed axially downward with respect to the outer circumferential portion of the bottom member 44. The outer circumferential portion of the bottom member 44 includes a support portion 48 extending diametrically outwardly, and a sealing abutment part 50 disposed diametrically outward of the support portion 48 and extends diametrically outwardly. That is, the support portion 48 and the sealing abutment part 50 are diametrically adjacent to each other with a stepped portion interposed therebetween, and the support portion 48 is located above in the axial direction of the sealing abutment part 50. Namely, the bottom wall portion of the bottom member 44 has a shallow ditch shape over an entire circumference at the outer circumferential portion, and a relatively large recessed shape at its central portion. In addition, a fixing flange 52 is integrally formed at an upper end portion of the outer rim of the bottom member 44.

Further, a bottom elastic member 54 is fixed to the bottom member 44. The bottom elastic member 54 is formed of a rubber elastic body, and includes a second support rubber elastic body in the form of an orifice wall portion 56 and a flexible film in the form of a diaphragm 58.

The orifice wall portion 56 has an annular block shape overall extending circumferentially with a generally rectangular cross sectional shape. The orifice wall portion 56 is formed with a notch 60 over a given circumferential length at an upper portion of an outer circumferential portion of the orifice wall portion 56. By means of this notch 60, the orifice wall portion 56 has a stepped shape over a given circumferential length where the outer circumferential portion is located axially downward of the inner circumferential portion. In the present embodiment, the orifice wall portion 56 is superposed on an upper face of the support portion 48 of the bottom member 44.

At the lower end portion of the outer circumferential side of the orifice wall portion 56, a sealing rubber 62 is integrally formed. The sealing rubber 62 has an annular shape overall and extends continuously over the entire circumference of the radially outside of the orifice wall portion 56. The sealing rubber 62 has an axial dimension smaller than that of the orifice wall portion 56. In the present embodiment, the axial dimension of the sealing rubber 62 is smaller than the axial dimension of the outer circumferential portion of the orifice wall portion 56 where the notch 60 is formed. In the present embodiment, the sealing rubber 62 is superposed on an upper face of the sealing abutment part 50 of the bottom member 44, and an outer circumferential surface of the sealing rubber 62 is bonded by vulcanization to an inner circumferential surface of a peripheral wall portion of the bottom member 44 over its entire circumference. In the present embodiment, the orifice wall portion 56 and the sealing rubber 62 are connected together via a connecting portion 63 whose axial dimension is smaller than that of the sealing rubber 62, thereby forming a groove between the orifice wall portion 56 and the sealing rubber 62 in the diametric direction, which are open to axially upward direction and extend over an entire circumference. Onto the connecting portion 63, there is superposed in the axial direction the lower end portion of the sealing rubber layer 40 projects axially downward from the second mounting member 14. That is, the lower end portion of the sealing rubber layer 40 is pressed into the diametric gap formed between the orifice wall portion 56 and the sealing rubber 62.

The diaphragm 58 is disposed radially inner side of the orifice wall portion 56. The diaphragm 58 is a thin rubber elastic body with a generally dome shape having a sufficient fold. The diaphragm 58 is integrally formed with the orifice wall portion 56, and extends so as to close the lower end opening of the bore of the orifice wall portion 56 of annular shape. The diaphragm 58 is not bonded or adhesive to the bottom member 44. In the state shown in FIG. 1 where the engine mount 10 is not installed on the vehicle, namely, in the state where no load is applied to the engine mount 10, the diaphragm 58 is spaced away from the bottom member 44 in the axial direction. With this arrangement, there is formed an air chamber 64 filled with an air in an axial space between the bottom wall portion of the bottom member 44 and the diaphragm 58. In the radially central portion of the bottom member 44, which is opposed to the diaphragm 58 in the axial direction, the cavity 46 is formed so as to provide a sufficient distance between the bottom member 44 and the diaphragm 58. With this arrangement, elastic deformation of the diaphragm 58 is not restricted by means of contact of the diaphragm 58 against the bottom member 44.

With the bottom elastic member 54 fixed in position, the bottom wall 44 is fixedly assembled with respect to the second mounting member 14. More specifically, with respect to the abutting flange 24 formed at the lower open end portion of the second mounting member 14, the fixing flange 52 formed at the upper open end of the bottom member 44 is superposed in the axial direction from the lower side. By means of the caulking portion 26, the fixing flange 52 is fixed by caulking to the second mounting member 14. Thus, the second mounting member 14 and the bottom member 44 are connected together in the axial direction. With this arrangement, the bottom elastic member 54 including the orifice wall portion 56 is fixed to the second mounting member 14.

With the second mounting member 14 and the bottom member 44 connected together in the axial direction as stated above, the orifice wall portion 56 is fitted into the second mounting member 14 via the sealing rubber layer 40. In this state, the orifice wall portion 56 is disposed in position diametrically within the second mounting member 14, while being compressed in the axial direction between the lower end face of the elastic support rubber 38 and the support portion 48 of the bottom member 44.

With the orifice wall portion 56 fitted into the second mounting member 14, the outer circumferential side opening of the notch 60 is closed by the inner surface of the second mounting member 14 coated by the sealing rubber layer 40. As a result, there is formed, by utilizing the notch 60, a circumferential groove 66 opened facing upward and extending circumferentially with a given length.

The sealing rubber 62, which is integrally formed with the orifice wall portion 56, is compressed in the axial direction between the abutting flange 24 of the second mounting member 14 and the sealing abutment part 50 of the bottom member 44. With this arrangement, a fluid sealing area 68, which will be described, is formed in a fluid-tightly sealed fashion with respect to the air chamber 64 at the connecting portion between the second mounting member 14 and the bottom member 44.

The lower open end portion of the second mounting member 14 is fluid-tightly closed by the bottom elastic member 54 having the diaphragm 58. That is, with the orifice wall portion 56 held in contact with the inner surface of the lower open end portion of the second mounting member 14, the central bore of the orifice wall portion 56 is fluid-tightly closed by means of the diaphragm 58, whereby the lower open end portion of the second mounting member 14 is closed with fluid-tight sealing.

With the lower open end portion of the second mounting member 14 is tightly closed by the bottom elastic member having the diaphragm 58, the fluid sealing area 68 filled with non-compressible fluid is formed in the axial spacing between the main rubber elastic body 16 and the diaphragm 58. As the non-compressible fluid sealed therein, there may be employed water, an alkylene glycol, a polyalkylene glycol, silicone oil, or the like, or the mixture thereof. In order to effectively achieve vibration damping action on the basis of fluid flow action through an orifice passage 84 (which will be described later), a low-viscosity fluid of 0.1 Pa.s or less will be employed, preferably. To fill the fluid sealing area 68 with the non-compressible fluid, the bottom member 44 assembled with the bottom elastic member 54 may be fixed by caulking to the second mounting member 14 bonded by vulcanization to the main rubber elastic body 16 within a mass of non-compressible fluid, for example.

Within the fluid sealing area 68, a metallic partition member 70 is housed and disposed. The partition member 70 is a rigid member formed of aluminum alloy or other metallic materials, and has a generally thin circular disk shape overall. The partition member 70 is bent at its radially intermediate portion to form an recessed groove 72 opened to upward and extending circumferentially with a given length. The partition member 70 spreads in the axis-perpendicular direction within the fluid sealing area 68, with its outer rim is located radially inside the inner surface of the sealing rubber layer 40 while being spaced away from the inner surface of the sealing rubber layer 40 with a given radial distance. In the present embodiment, the partition member 70 may be formed by pressing a thin metal plate to form the recessed groove 72.

The outer rim of the partition member 70 is positioned radially inward of the second mounting member 14. The elastic support rubber 38, which is integrally formed with the main rubber elastic body 16, is superposed on the outer rim of the partition member 70 from the axially upper side, while the orifice wall portion 56 is superposed against the outer rim of the partition member 70 from the axially lower side. That is, the partition member 70 is pinched at its outer rim between the elastic support rubber 38 and the orifice wall portion 56. As will be apparent from FIG. 1, the outer rim of the partition member 70 is spaced away from the inner surface of the second mounting member 14 over the entire circumference, and is positioned diametrically inward of the inner surface of the second mounting member 14 by a given radial distance: α (α>0).

With this arrangement, the partition member 70 is pinched by and between the elastic support rubber 38 and the orifice wall portion 56, so that the partition member 70 is supported by the second mounting member 14 while being displaceable relative to the second mounting member 14 due to elastic deformation of the elastic support rubber 38 and the orifice wall portion 56. As shown in FIG. 1, an outer circumferential wall portion of the recessed groove 72 of the partition member 70 is held in contact with the inner circumferential surface of the orifice wall portion 56 in the axis-perpendicular direction, whereby the outer circumferential wall portion of the recessed groove 72 is press fitting into the bore of the orifice wall portion 56. Namely, the partition member 70 is supported by the second mounting member 14 in a substantially floating state.

The orifice wall portion 56 is compressed in the axial direction between the partition member 70 and the bottom wall portion of the bottom member 44, so that the upper end face of the orifice wall portion 56 is forcedly pressed and held in close contact against the partition member 70. In the present embodiment, the orifice wall portion 56 and the sealing rubber 62 are held in contact with the different positions of the bottom member 44. As a result, the orifice wall portion 56 is compressed between the opposite faces of the orifice partition member 70 and the support portion 48 of the bottom member 44, while the sealing rubber 62 is compressed by the opposite faces between the abutting flange 24 of the second mounting member 14 and the sealing abutment part 50 of the bottom member 44. Furthermore, a compression ratio of the orifice wall portion 56 in the axial direction (compression amount of rubber/initial dimension of rubber) and a compression ratio of the sealing rubber 62 in the axial direction are made different from each other. In the present embodiment, the compression ratio of the sealing rubber 62 is greater than that of the orifice wall portion 56, whereby it makes it possible to realize both of the desired sealing capability by means of the sealing rubber 62 and the desired floating support of the partition member 70 by means of the orifice wall portion 56.

With the partition member 70 spreads in the axis-perpendicular direction while being supported by and between the elastic support rubber 38 constituting a part of the wall of the fluid sealing area 68 and the orifice wall portion 56, the fluid sealing area 68 is divided into two regions on axially opposite sides of the partition member 70. Namely, on the axially upper side of the partition member 70, there is formed a pressure-receiving chamber 74 whose wall is partially defined by the main rubber elastic body 16 and will induce fluid pressure fluctuation upon input of vibration, and on the axially lower side of the partition member 70, there is formed an equilibrium chamber 76 whose wall is partially defined by the diaphragm 58 and is able to change its volume readily.

The outer rim of the partition member 70 extends over the opening of the circumferential groove 66 formed by utilizing the notch 60 of the orifice wall portion 56, and the elastic support rubber 38 is located over the outer circumferential portion of the opening of the circumferential groove 66. With this arrangement, the elastic support rubber 38 and the partition member 70 are cooperate to close the opening of the circumferential groove 66 over the entire length thereof, thereby providing a tunnel-like passage extending circumferentially with a given length by utilizing the circumferential groove 66.

On the side of a first end of the tunnel-like passage, a cutout 78 is formed at the outer rim of the partition member 70, while a recessed portion 80 is formed at the lower end portion of the elastic support rubber 38. Therefore, the first end of the tunnel-like passage is held in fluid communication with the pressure-receiving chamber 74 via the cutout 78 and the recessed portion 80. On the side of the other end of the tunnel-like passage, a communication passage 82 extending radially inwardly is formed by cutting out the inside edge of the inner circumferential wall of the orifice wall portion 56, while the recessed groove 72 of the partition member 70 is formed not to cover a radially inner side opening of the communication passage 82. Therefore, the other end of the tunnel-like passage is held in fluid communication with the equilibrium chamber 76 via the communication passage 82 and a gap formed by the circumferential ends of the recessed groove 72. That is, by utilizing this tunnel-like passage, there is formed an orifice passage 84 whereby the pressure-receiving chamber 74 and the equilibrium chamber 76 are held in fluid communication via the orifice passage 84. In the present embodiment, the passage length and cross sectional area of the orifice passage 84 may be adjusted so that the engine mount 10 is able to exhibit excellent vibration damping effect with respect to low frequency and large amplitude vibration at around 10 Hz, such as engine shakes in the automotive vehicle.

According to the automotive engine mount 10 of the present invention, when engine shakes or other low frequency and large amplitude vibrations are applied between the first mounting member 12 and the second mounting member 14, the engine mount 10 will exhibit excellent vibration damping effect on the basis of flow action or resonance of the fluid flowing through the orifice passage 84. In the present embodiment particularly, since the partition member 70, which constitutes a fluid pressure absorbing mechanism (which will be described later), is a rigid member so that an excess deformation of the partition member 70 upon input of low frequency large amplitude vibration is prevented. Thus, a sufficient amount of flow of the fluid through the orifice passage 84 can be obtained without avoiding absorption of the pressure fluctuation within the pressure-receiving chamber 74 by the deformation of the partition member 70, thereby ensuring excellent damping effect based on flow action of the fluid flowing through the orifice passage 84.

When engine idling vibration or other high frequency and small amplitude vibrations are applied between the first mounting member 12 and the second mounting member 14, the orifice passage 84 becomes substantially closed due to anti-resonance effect of the fluid, and the partition member 70 will undergo displacement in the axial direction so as to exhibit fluid pressure absorbing action. Namely, the partition member 70 is supported and pinched by and between the elastic support rubber 38 and the orifice wall portion 56, which are both formed by rubber elastic body, so that the partition member 70 is able to be slightly displaced in the axial direction based on the elastic deformation of the elastic support rubber 38 and the orifice wall portion 56. Accordingly, upon input of high frequency and small amplitude vibrations, the partition member 70 undergoes slight displacement in the axial direction based on pressure fluctuation induced in the pressure-receiving chamber 74, whereby the pressure fluctuation induced in the pressure-receiving chamber 74 can be transmitted or checked to the equilibrium chamber 76 side. With this arrangement, the engine mount 10 is able to exhibit vibration-damping effect based on fluid pressure absorption mechanism. As will be understood from the aforementioned description, by elastically supported the partition member 70 by the second mounting member 14 via the elastic support rubber 38 and the orifice wall portion 56, the fluid pressure absorption mechanism to check fluid pressure fluctuation induced in the pressure-receiving chamber 74 to the equilibrium chamber 76 is provided. The fluid pressure absorption mechanism, which constituted by including the partition member 70, may be suitably adjusted in terms of tuning frequency, for example, by suitably adjusting rigidity of the elastic support rubber 38 and the orifice wall portion 56, whereby vibration damping characteristics of the engine mount 10 can be changed or adjusted.

Moreover, since the fluid pressure absorption mechanism is able to formed by utilizing the partition member 70 that is also utilized to partition the pressure-receiving chamber 74 and the equilibrium chamber 76 from each other. Thus, the fluid pressure absorption mechanism can be provided without needing special components and with the reduced number of components as well as simple structure. Thus, the present engine mount 10 will enjoy improved efficiency in manufacture, reduced manufacturing costs and the like.

In the present embodiment, the sealing rubber 62, which is adapted to seal the connecting portion 63 between the second mounting member 14 and the bottom member 44, is integrally formed with the orifice wall portion 56. Likewise, the diaphragm 58 is integrally formed with the orifice wall portion 56. Thus, the number of components formed by rubber elastic body can be reduced, thereby realizing improved manufacturing efficiency and reduced manufacturing costs.

The use of the rigid partition member 70 as the component of the fluid pressure absorbing mechanism makes it possible to effectively reduce or avoid fluid pressure absorption of pressure fluctuation in the pressure-receiving chamber 74 through excessive deformation of the fluid pressure absorption mechanism upon input of low frequency and large amplitude vibrations. Thus, a sufficient amount of fluid to be flow through the orifice passage 84 is able to obtained, thereby ensuring desired vibration damping effect based on flow action of the fluid through the orifice passage 84.

The elastic support rubber 38 and the orifice wall portion 56, which are cooperate together to pinch the partition member 70 therebetween, are both superposed against the partition member 70 in the axial direction. Thus, when the partition member 70 undergoes slight displacement, the elastic support rubber 38 and the orifice wall portion 56 will undergo compression and tensile deformation. This makes it possible to prevent the elastic support rubber 38 and the orifice wall portion 56 from undergoing share stress, thereby ensuring improved durability of the elastic support rubber 38 and the orifice wall portion 56.

In the present embodiment, the air chamber 64 fluid-tightly closed from the outside is formed in the axial spacing between the bottom member 44 and the diaphragm 58. Thus, excessive elastic deformation of the diaphragm 58 can be prevented by air spring induced by the air sealed within the air chamber 64, so that the durability of the diaphragm 58 will be improved.

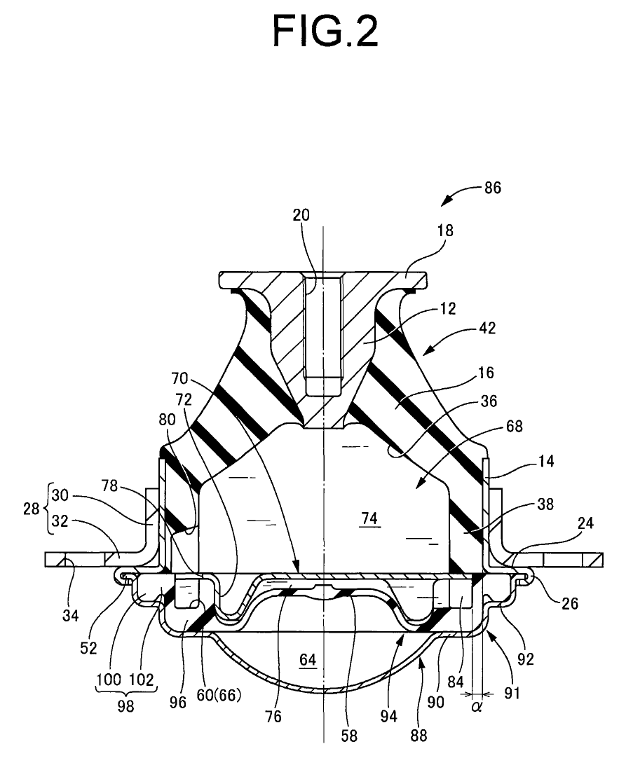

Referring next to FIG. 2, shown is a fluid filled-type vibration damping device in the form of an automotive engine mount 86 according to a second embodiment of the present invention. In the following description, the same reference numerals as used in the illustrated embodiment are used for identifying structurally and functionally corresponding elements, to facilitate understanding of the instant embodiment, and omit redundant explanation.

The engine mount 86 according to the present embodiment includes a bottom member 88 of metal serving as a fixing member. The bottom member 88 is a metal member of stepped circular cup shape overall, and includes a bottom wall portion that has a semi-spherical or dome shape projecting downwardly. The outer circumferential portion of the bottom member 44 includes a support portion 90 extending diametrically outwardly, and a fixing flange 52 is integrally formed at an upper end portion of a peripheral wall portion 91 of the bottom member 88. Further, a sealing abutment part 92 is formed at an axially intermediate portion of the peripheral wall portion 91 of the bottom member 88, so as to extend in the axis-perpendicular direction. Therefore, the peripheral wall portion 91 includes an axially upper large-diameter portion and an axially lower small-diameter portion with the sealing abutment part 92 interposed therebetween.

A bottom elastic member 94 is fixed to the bottom member 88. The bottom elastic member 94 is formed of a rubber elastic body, and includes a second support rubber elastic body in the form of an orifice wall portion 96, a flexible film in the form of a diaphragm 58 and a sealing rubber 98.

The orifice wall portion 96 has an annular block shape overall, and superposed on and fixed to the support portion 90 of the bottom member 88 from the axially upper side. A circumferential groove 66 is formed at a radially intermediate portion of the orifice wall portion 96. The circumferential groove 66 is opened facing upward, and extending circumferentially with a given length.

The sealing rubber 98 is disposed at the outer circumferential side of the orifice wall portion 96, and is formed integrally with the upper end of the orifice wall portion 96 project radially outwardly. In the present embodiment, particularly, the sealing rubber 98 includes a sealing part 100 and a connecting part 102, so that the annular sealing part 100 is connected to the orifice wall portion 96 over its entire circumference via the annular connecting part 102 having smaller diameter than the sealing part 100. The sealing rubber 98 is superposed at the sealing part 100 on the sealing abutment part 92 from the axially upper side, and is spaced apart in the axially upwardly at the connecting part 102 from the bottom member 88.

The bottom member 88 fixed with the bottom elastic member 94 is superposed at the fixing flange 52 against the abutting flange 24 of the second mounting member 14 from the axially lower side. By means of the caulking portion 26, the fixing flange 52 is fixed by caulking to the second mounting member 14. Thus, the bottom member 88 is fixed to the second mounting member 14 to thereby close the lower end opening of the second mounting member 14.

With the bottom member 88 affixed to the second mounting member 14 as described above, the sealing rubber 98 is compressed by and pinched between the sealing abutment part 92 of the bottom member 88 and the abutting flange 24 of the second mounting member 14 in the axial direction. With this arrangement, fluid-tight sealing at the connecting portion between the second mounting member 14 and the bottom member 88 from the outside can be realized by means of the sealing rubber 98.

The orifice wall portion 96 is held in abutting contact with the partition member 70 disposed within the fluid sealing area 68, and is compressed between the bottom member 88 and the partition member 70 by a given amount in the axial direction. With this arrangement, the bottom member 88 and the partition member 70 are superposed on each other fluid-tightly, and the main rubber elastic body 16 and the partition member 70 are superposed on each other fluid-tightly.

The opening of the circumferential groove 66 is closed by the outer rim of the partition member 70, so that the orifice passage 84 for fluid communication between the pressure-receiving chamber 74 and the equilibrium chamber 76 is formed by utilizing the circumferential groove 66 with a given circumferential length.

The automotive engine mount 86 of construction according to the present embodiment, is able to ensure the vibration damping effect on the basis of flow action of the fluid through the orifice passage 84 upon input of low frequency large amplitude vibration, and the vibration damping effect on the basis of fluid pressure absorption mechanism upon input of high-frequency and small amplitude vibration, like in the first embodiment. Also, the fluid pressure absorption mechanism can be realized by the reduced number of components and with the simple structure. In addition, the number of components formed of rubber elastic body can be reduced, thereby ensuring improved manufacturing efficiency and reduced manufacturing costs.

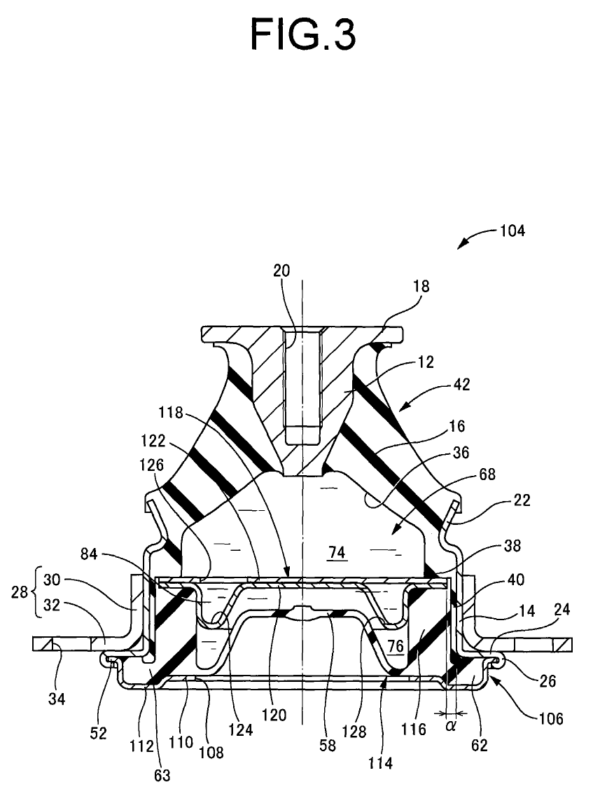

Referring next to FIG. 3, shown is a fluid filled-type vibration damping device in the form of an automotive engine mount 104 according to a third embodiment of the present invention. The engine mount 104 according to the present embodiment includes a bottom member 106 of metal serving as a fixing member. The bottom member 106 is a metal member of shallow dish shape overall, and includes a circular bore 108 extending through the central portion of a bottom wall portion in the axial direction. An inner circumferential portion of the periphery of the bottom member 106 is formed as a support portion 110, while an outer circumferential portion of the periphery of the bottom member 106 is formed as a sealing abutment part 112. A step is formed between the support portion 110 and the sealing abutment part 112 so that the support portion 110 is located axially above of the sealing abutment part 112. In addition, a fixing flange 52 is integrally formed at an upper end portion of the peripheral wall portion 91 of the bottom member 106.

A bottom elastic member 114 is fixed to the bottom member 106. The bottom elastic member 114 is formed of a rubber elastic body, and includes a second support rubber elastic body in the form of an annular support portion 116, a flexible film in the form of a diaphragm 58, and a sealing rubber 62. The annular support portion 116 has a generally annular block shape while continuously extending with the substantially same rectangular cross section over an entire circumference. The annular support portion 116 is fixed to the support portion 110 of the bottom member 106 and the sealing rubber 62 is fixed to the sealing abutment part 112.

The bottom member 106 fixed with the bottom elastic member 114 is connected and fixed to the second mounting member 114. Namely, the fixing flange 52 formed at the upper open end portion of the bottom member 106 is superposed against to the abutting flange 24 formed at the lower open end portion of the second mounting member 14 from the axially lower side. By means of the caulking portion 26, the fixing flange 52 is fixed by caulking to the second mounting member 14. Thus, the bottom member 106 is connected to the second mounting member 14 in the axial direction.

With the second mounting member 14 and the bottom member 106 connected together as described above, a partition member 118 is disposed within the fluid sealing area 68, while spreading in the axis-perpendicular direction. The partition member 118 has a generally circular disk shape overall, and includes the partition body 120 and a lid plate member 122.

The partition body 120 is a generally circular disk shape and is bent at its radially intermediate portion so as to project downwardly, thereby forming a recessed groove 124 extending circumferentially with a given length. The partition body 120 may be formed by pressing the thin metal plate, for example.

The lid plate member 122 is a thin circular disk shape member, and has a outside diameter substantially same as the partition body 120. This lid plate member 122 is superposed on the partition body 120 from the axially upper side, so that the partition member 118 in the present embodiment is composed of the partition body 120 and the lid plate member 122. More specifically, the lid plate member 122 is held in contact with the partition body 120 at its diametrically central portion and at its peripheral portion, while the diametrically intermediate portion of the lid plate member 122 is used to close the opening of the recessed groove 124. As a result, a tunnel-like passage extending circumferentially with a given length is formed by utilizing the recessed groove 124. That is, the tunnel-like passage is formed by a rigid wall defined by the partition member 118.

The partition member 118 of construction as described above is disposed within the fluid sealing area 68. Namely, the outer circumferential portion of the partition member 118 is disposed between the elastic support rubber 38 integrally formed with the main rubber elastic body 16 and the annular support portion 116 of the bottom elastic member 114, so that the partition member 118 is pinched between the elastic support rubber 38 and the annular support portion 116. With this arrangement, the partition member 118 is elastically supported by the second mounting member 14, and is able to displaced relative to the second mounting member 14 by means of the elastic deformation of the elastic support rubber 38 and the annular support portion 116.

With the partition member 118 disposed within the fluid sealing area 68, the fluid sealing area 68 is divided into the two parts disposed on opposite sides of the partition member 118 vertically. Namely, the pressure-receiving chamber 74 is formed on the upper side of the partition member 118, while the equilibrium chamber 76 is formed on the lower side of the partition member 118.

Further, the orifice passage 84 is formed by utilizing a tunnel-like passage formed within the partition member 118. Namely, on the side of a first end of the tunnel-like passage, a communication hole 126 is formed through the lid plate member 122, while on the side of the other end of the tunnel-like passage, a communication hole 128 extending radially inwardly through the inside peripheral wall of the recessed groove 124. Thus, the tunnel-like passage is held in communication through the communication holes 126, 128 with the pressure-receiving chamber 74 and the equilibrium chamber 76. As will be understood from the aforementioned description, the orifice passage 84 is rigid by forming its entire wall with the partition member 118.

In the engine mount 104 of construction according to the present embodiment, the same advantages or effect as in the first and second embodiments can be provided.

In the present embodiment, the entire wall of the orifice passage 84 is formed by the rigid partition member 118. Therefore, the change in cross sectional area of the orifice passage 84 can be prevented, so that the orifice passage 84 can be tuned to a specific frequency with highly precisely. Thus, the engine mount 104 is able to exhibit vibration damping effect on the basis of the flow action of the fluid through the orifice passage 84 more advantageously.

While the present invention has been described in detail in its presently preferred embodiments for illustrative purpose only, it is to be understood that the invention is by no means limited to the details of the illustrated embodiment, but may be otherwise embodied.

For instance, the structure of the orifice passage is not limited to the specific ones as described in the illustrated embodiments at all. It may be possible to employ a plurality of orifice passages tuned to different frequency ranges, for example. Also, the orifice passage is not necessarily to extend in the circumferential direction.

The partition member is not necessarily formed by a metallic material, but may be formed by rigid synthetic resin materials or the like. The partition member formed of a metallic member may be coated by a rubber layer, if appropriate.

The fixing member is not necessarily fixed to the second mounting member by caulking, but may be fixedly assembled with the second mounting member with a variety of fixing process or means, such as press fitting, drawing operation, pinching or the like. For instance, an annular fixing member may be bonded by vulcanization to an outer circumferential surface of the first support rubber elastic body, and then the fixing member is press fitted into the cylindrical bore of the second mounting member, whereby the first support rubber elastic body is supported by the second mounting member.

While in the illustrated embodiment, the orifice wall portion serving as the second support rubber elastic body and the sealing rubber is formed integrally with each other, the present invention includes a mode where the second support rubber elastic body and the sealing rubber are formed separately. This arrangement makes it possible to differentiate materials of the second support rubber elastic body and the sealing rubber from each other so that floating support of the partition member by the second support rubber elastic body and fluid-tight sealing by means of the sealing rubber can be established advantageously.

While in the illustrated embodiment, the orifice wall portion serving as the second support rubber elastic body and the diaphragm serving as a flexible film are formed integrally with each other, it may be possible to form these member separately. More specifically, an annular fixing metal member is bonded by vulcanization to an outer peripheral edge of the diaphragm 58, and an outside flange is integrally formed at one axial end of the fixing metal. The outside flange is superposed against the abutting flange 24 of the second mounting member 14 and the fixing flange 52 of the bottom member 44, and then is fixed by caulking to the second mounting member 14 and the bottom member 44. Thus, the diaphragm 58 formed separately from the orifice wall portion 56 is able to be fixed to the second mounting member 14. By employing the flexible film formed separately from the second support rubber elastic body, and differentiating materials of the second support rubber elastic body and the flexible film, it is possible to exhibit further enhanced fluid pressure absorbing capability.

It is also to be understood that the present invention may be embodied with various changes, modifications and improvements which may occur to those skilled in the art, without departing from the spirit and scope of the invention.

What is claimed is:

1. A fluid-filled type vibration-damping device comprising:
a first mounting member;
a second mounting member of tubular shape, the first mounting member disposed on a first axial open-end side of the second mounting member with a space therebetween;
a main rubber elastic body elastically connecting the first mounting member and the second mounting member with a central portion thereof being bonded by vulcanization to the first mounting member and with an outer circumferential portion thereof being bonded by vulcanization to the second mounting member;
a partition member supported by the second mounting member such that the partition member spreads in an axis perpendicular direction to form on one side thereof a pressure receiving chamber partially defined by the main rubber elastic body and on an other side thereof an equilibrium chamber partially defined by a flexible film, the pressure receiving chamber and the equilibrium chamber being filled with non-compressible fluid sealed therein; and
an orifice passage for connecting the pressure receiving chamber and the equilibrium chamber to each other,
wherein the outer circumferential portion of the main rubber elastic body extend axially inwardly on an inner circumferential surface of the second mounting member to form a first support rubber elastic body,
an outer peripheral portion of the partition member is superposed onto an axial end face of the first support rubber elastic body while being spaced away radially inwardly from the second mounting member,
an annular second support rubber elastic body is assembled into the second mounting member from a second axial open end side of the second mounting member such that the second support rubber elastic body is superposed in an axial direction onto the outer peripheral portion of the partition member on a side opposite from the first support rubber elastic body so that the partition member is pinched between the first support rubber elastic body and the second support rubber elastic body, the partition member thereby being supported with respect to the second mounting member in a displaceable fashion owing to elastic deformation of the first and second elastic support bodies so as to provide a fluid pressure absorbing mechanism capable of transmitting fluid pressure fluctuation of the pressure receiving chamber to the equilibrium chamber to absorb the fluid pressure fluctuation.

2. The fluid-filled type vibration damping device according to claim 1, wherein the second support rubber elastic body and the flexible film are formed integrally.

3. The fluid-filled type vibration damping device according to claim 1, wherein a fixing member is fixed to the second axial open end side of the second mounting member, and the second support rubber elastic body is assembled to the second mounting member by means of the fixing member.

4. The fluid-filled type vibration damping device according to claim 3, wherein a sealing rubber is formed integrally with the second support rubber elastic body so as to extend over an entire circumference of an outer circumferential portion of the second support rubber elastic body, and is pinched in the axial direction between the second mounting member and the fixing member.

5. The fluid-filled type vibration damping device according to claim 4, wherein the sealing rubber has an axial length smaller than that of the second support rubber elastic body.

6. The fluid-filled type vibration damping device according to claim 4, wherein an outer rim of the fixing member is fixed by caulking against the second mounting member so that by means of the fixing member the second support rubber elastic body is superposed against onto the partition member to pinch the partition member between the first and second support rubber elastic bodies in the axial direction, while the sealing rubber is pinched between the fixing member and the second mounting member in the axial direction.

7. The fluid-filled type vibration damping device according to claim 1, wherein the partition member is of thin circular disk shape, and the second support rubber elastic body is of annular block shape, while the orifice passage is formed by closing an opening of a groove formed onto the second support rubber elastic body by means of the partition member.

8. The fluid-filled type vibration damping device according to claim 4, wherein a sealing rubber layer extends axially downward from an outer peripheral edge of an axially lower end of the first support rubber elastic body, and a projecting end portion of the sealing rubber layer is press fitted into a gap between the second support rubber elastic body and the sealing rubber to give a fluid-tight sealing therebetween.
